(19) United States
(12) Patent Application Publication
(10) Pub. No.: US 2016/0200307 A1
(43) Pub. Date: Jul. 14, 2016

(54) Brake System for Motor Vehicles

(71) Applicant: CONTINENTAL TEVES AG & CO. OHG, Frankfurt (DE)

(72) Inventor: Hans-Jörg Feigel, Rosbach (DE)

(21) Appl. No.: 14/912,985

(22) PCT Filed: Aug. 8, 2014
(86) PCT No.: PCT/EP2014/067048

§ 371 Date: Feb. 19, 2016

(30) Foreign Application Priority Data
Aug. 20, 2013 (DE) 10 2013 216 477.7

(51) Int. Cl. B60T 13/68; B60T 7/12; B60T 13/58; B60T 7/04

(52) U.S. Cl. CPC B60T 13/686; B60T 7/042; B60T 7/12; B60T 13/588

(57) ABSTRACT

A brake system for motor vehicles controlled in a brake-by-wire operating mode by the vehicle driver and independently. A normally open simulator valve is used, and no isolating valves are required for decoupling the master brake cylinder pressure chambers from the wheel brakes. The simulation device is not connected to one of the pressure chambers of the master brake cylinder and is isolated hydraulically from the pressure chambers of the master brake cylinder, but is coupled directly to the movement of the first master brake cylinder piston. The first master brake cylinder piston is formed as a stepped piston with a circular face and an annular face, the circular face delimits the first pressure chamber and the annular face delimits the hydraulic chamber, wherein a pressure effect in the chamber corresponds to a force which acts on the first master brake cylinder piston against the actuation direction.

### CROSS REFERENCE TO RELATED APPLICATIONS

This application claims priority to German Patent Application No. 10 2013 216 477.7, filed Aug. 20, 2013 and PCT/EP2014/067048, filed Aug. 8, 2014.

### FIELD OF THE INVENTION

The present invention concerns a brake system for motor vehicles.

A brake system for motor vehicles is known for example from DE 10 2011 081 463 A1. The previously known brake system includes a master brake cylinder which can be actuated by means of a brake pedal, with two pressure chambers, wheel brakes, an electrically controllable pressurization device, a pressure-regulating valve arrangement with two valves per wheel brake, two further valves per brake circuit, of which both isolating valves are required for decoupling the master brake cylinder pressure chambers from the wheel brakes in brake-by-wire operating mode, and a simulation device which is connected to the pressure chambers of the master brake cylinder and which can be switched on and off via a simulator release valve. In order to achieve a high availability of the brake system even in fallback operating mode, the brake system as a whole includes thirteen valves and the simulator release valve must be configured normally closed so that, in the case of failure of the electrical power supply to the brake system, in fallback operating mode, the switch-off of the simulation device is guaranteed together with the possibility of a hydraulic pressure build-up at the wheel brakes by the vehicle driver. The disadvantage with the use of a normally closed simulator release valve is that, in the case of soiling or improper operation of the valve, under certain circumstances this may no longer close completely so that a hydraulic intervention by the vehicle driver on the wheel brakes in fallback operating mode may no longer be possible, or only to a restricted extent. Furthermore, the large number of valves leads to high production costs for the brake system.

The object of the present invention is therefore to provide a brake system which has a further improved availability and at the same time can be produced economically.

This object is achieved according to the invention by the brake system described herein.

### SUMMARY AND INTRODUCTORY DESCRIPTION

The invention is based on the concept that the first master brake cylinder piston coupled to the brake pedal is formed as a stepped piston, the annular face of which delimits a hydraulic chamber which is connected to the simulator chamber of the hydraulically actuatable simulation device.

One advantage of the invention is that a normally open simulator valve can be used, and that no isolating valves are required for decoupling the master brake cylinder pressure chambers from the wheel brakes. This is achieved in that the simulation device is not connected to one of the pressure chambers of the master brake cylinder, i.e. it can be isolated hydraulically from the pressure chambers of the master brake cylinder, but is still coupled directly to the movement of the first master brake cylinder piston.

The first master brake cylinder piston is thus formed as a stepped piston with at least a circular face and an annular face, the circular face of which delimits the first pressure chamber and the annular face of which delimits the hydraulic chamber, wherein a pressure effect in the chamber corresponds to a force which acts on the first master brake cylinder piston against the actuation direction.

Preferably, a hydraulic connection is provided between the first pressure chamber and the pressure medium storage container, in which connection an electrically actuatable discharge valve is arranged. In this way, in particular also when the first master brake cylinder piston is actuated, the first pressure chamber can be held pressureless in brake-by-wire operating mode. In this way, the brake pedal curve in the response region is not influenced by the movement of the second master brake cylinder piston. The discharge valve is particularly preferably configured normally closed, so that in fallback level, actuation of the wheel brakes by the vehicle driver is possible. The discharge valve furthermore has the advantage that if a transition to fallback operating mode takes place during a brake pedal actuation, by closure of the discharge valve, a direct actuation of the wheel brakes by the vehicle driver is possible without loss of brake pedal travel.

The simulator valve is preferably configured normally open so that contamination or incomplete closure of the simulator valve has no effect on the function capacity of the fallback operating mode.

According to a preferred embodiment of the brake system, a hydraulic connection is provided between the chamber and the first pressure chamber, in which connection an electrically actuatable prefill valve is arranged. In a second fallback operating mode, the prefill valve allows a shortening of the brake pedal travel.

Preferably, a hydraulic connection is provided between the chamber and the pressure medium storage container, in which connection the simulator valve is arranged. Particularly preferably, a check valve opening in the direction of the chamber is connected in parallel to the simulator valve.

Preferably, each first wheel valve is arranged in the connection between the wheel brake and the assigned pressure chamber, wherein no further valve is arranged in the connection between the first wheel valve and the pressure chamber, i.e. in each case, the only valve arranged in a hydraulic line connecting the respective pressure chamber to a wheel brake is the first wheel valve.

According to a refinement of the invention, a hydraulic connection is provided between the second pressure chamber and the chamber, or between the second pressure chamber and the simulator chamber, in which connection an electrically actuatable isolating valve is arranged which, particularly preferably, is configured normally open so that the wheel brakes connected to the second pressure chamber are in connection with the pressure medium storage container. This is advantageous for allowing a continuous pressure balancing. This connection is advantageously blocked by actuation of the second master brake cylinder piston.

According to a preferred embodiment of the brake system according to the invention, at least one radial bore is arranged in the second master brake cylinder piston, such that when the second master brake cylinder piston is not actuated, the second pressure chamber is connected via the radial bore and a container port to the pressure medium storage container, wherein the connection is blocked by actuation of the second master brake cylinder piston, and a hydraulic connection is provided between the container port and the chamber, in which connection the isolating valve is arranged. This allows a compact installation form.

At least when the first master brake cylinder piston is actuated, the first pressure chamber and the hydraulic chamber are preferably sealed against each other hydraulically.

Preferably, the first pressure chamber and the hydraulic chamber are not connected together hydraulically when the brake pedal is actuated in brake-by-wire operating mode.

Preferably, at least one radial bore is arranged in the first master brake cylinder piston such that when the first master brake cylinder piston is not actuated, the first pressure chamber is connected to the chamber via the radial bore, wherein the connection is blocked by actuation of the first master brake cylinder piston. This is advantageous in order to bring the wheel brakes connected to the first pressure chamber into connection with the pressure medium storage container for pressure balancing.

In order to pressurize the wheel brakes of the second brake circuit by means of the pressurization device in brake-by-wire operating mode, preferably a hydraulic connection is provided between the pressurization device and the second pressure chamber. This connection is particularly preferably blocked by actuation of the second master brake cylinder piston. In brake-by-wire operating mode therefore, the wheel brakes assigned to the second pressure chamber are pressurized via the connection between the pressurization device and the second pressure chamber and the first wheel valves.

According to a refinement of the invention, at least one radial bore is provided in the second master brake cylinder piston such that when the second master brake cylinder piston is not actuated, the second pressure chamber is connected to the pressurization device via the radial bore, wherein the connection is blocked by actuation of the second master brake cylinder piston.

Preferably, a second electrically controllable wheel valve of the pressure-regulating valve arrangement is assigned at least to the wheel brakes of the brake circuit assigned to the first pressure chamber, which valve is arranged in a hydraulic connection between the pressurization device and the wheel brake. Particularly preferably, a second electrically controllable wheel valve of the pressure-regulating valve arrangement is assigned to each of the wheel brakes of both brake circuits, which valve is arranged in a hydraulic connection between the pressurization device and the wheel brake.

According to a preferred embodiment of the brake system according to the invention, the second wheel valves assigned to the wheel brakes are configured normally closed, and no further valve is arranged in the respective connection between the pressurization device and the second wheel valve. This is particularly preferred for the second wheel valves of the first pressure chamber.

According to another preferred embodiment of the brake system according to the invention, the second wheel valves assigned to the wheel brakes of the first pressure chamber are configured normally open, and a normally closed circuit valve is arranged in the connection between the second wheel valves and the pressurization device.

Furthermore, according to one embodiment, it is preferred that a second electrically controllable, normally closed wheel valve of the pressure-regulating valve arrangement is assigned to each of the wheel brakes of the brake circuit assigned to the second pressure chamber, which valve is arranged in a hydraulic connection between the wheel brake and the pressure medium storage container. Here no further valve is arranged in the connection between the second wheel valve and the pressure medium storage container.

The brake system preferably includes at least one electronic control and regulating unit for controlling the simulator valve, the pressurization device and the pressure-regulating valve arrangement, and any further valves of the brake system, in particular the discharge valve and/or the isolating valve.

A further advantage of the invention is that fewer electrically actuatable valves are required than in brake systems known from the prior art. The brake system according to the invention is thus smaller, more economic and lighter. Furthermore, the invention offers the advantage that on a transition to fallback operating mode, there is no extension of the brake pedal travel. It is furthermore advantageous that a rapid pressure build-up is possible by means of the pressurization device, since only the first wheel valve is arranged between the pressurization device and a wheel brake, so that there is no hydraulic resistance from a further valve.

Further preferred embodiments of the invention arise from the description which follows with reference to figures.

### BRIEF DESCRIPTION OF THE DRAWINGS

The drawings show diagrammatically:

FIG. 1 a first exemplary embodiment of a brake system according to the invention,

FIG. 2 a second exemplary embodiment of a brake system according to the invention,

FIG. 3 a third exemplary embodiment of a brake system according to the invention,

FIG. 4 a fourth exemplary embodiment of a brake system according to the invention,

FIG. 5 a fifth exemplary embodiment of a brake system according to the invention,

FIG. 6 a sixth exemplary embodiment of a brake system according to the invention,

FIG. 7 a seventh exemplary embodiment of a brake system according to the invention,

FIG. 8 an eighth exemplary embodiment of a brake system according to the invention,

FIG. 9 a ninth exemplary embodiment of a brake system according to the invention,

FIG. 10 a twelfth exemplary embodiment of a brake system according to the invention,

FIG. 11 a fifteenth exemplary embodiment of a brake system according to the invention, and

FIG. 12 a seventeenth exemplary embodiment of a brake system according to the invention.

### DETAILED DESCRIPTION

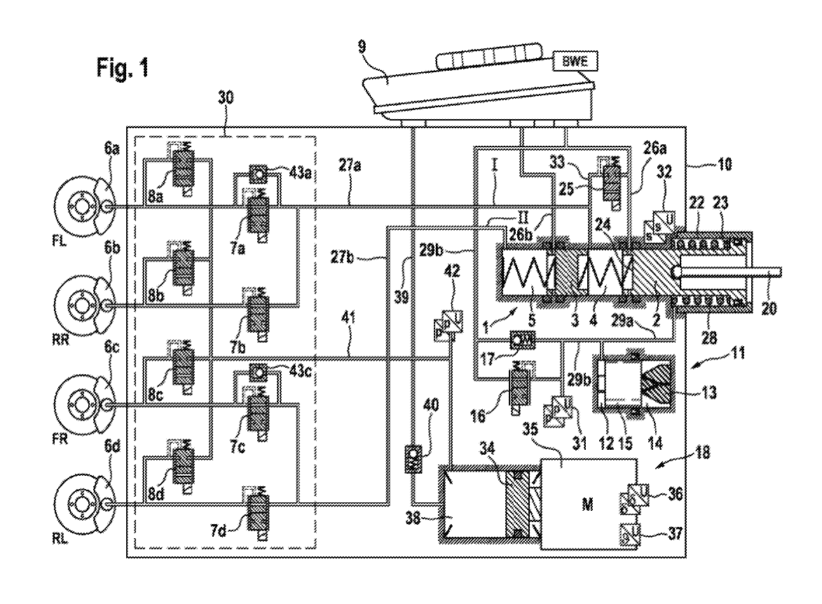

The brake system shown in FIG. 1 according to the first exemplary embodiment substantially includes a hydraulic master brake cylinder 1 which can be actuated by means of actuation of the brake pedal, a hydraulically actuatable simulation device 11 cooperating with the master brake cylinder 1, a pressure medium storage container 9 assigned to the master brake cylinder 1, an electrically controllable pressurization device 18, hydraulically actuatable wheel brakes 6a-6d, an electrically controllable pressure-regulating valve arrangement 30 for regulating and/or controlling the wheel brake pressures set at the wheel brakes, and an electronic control and regulating unit (ECU) (not shown).

The master brake cylinder 1 has in a housing 10 two hydraulic master brake cylinder pistons 2, 3 arranged one behind the other (primary piston 2, secondary piston 3) which together with the housing 10 delimit hydraulic pressure chambers 4, 5 (primary pressure chamber 4, secondary pressure chamber 5). The pressure chambers 4, 5 are connected firstly to the pressure medium storage container 9 via radial bores formed in the master brake cylinder pistons 2, 3 and corresponding pressure balancing lines 26a, 26b, wherein the connections may be blocked by a relative movement of the pistons 2, 3 in the housing 10, and secondly to the pressure-regulating valve arrangement 30 by means of hydraulic lines 27a, 27b. The hydraulic lines 27a, 27b each belong to a brake circuit carrying reference numerals I and II respectively. In this example, a normally open, analog or analog-controlled first wheel valve 7a-7d of the pressure-regulating valve arrangement 30 is assigned to each wheel brake 6a-6d, which valve is arranged in the hydraulic connection between the pressure chamber 4, 5 and the wheel brake 6a-6d. In this example, no further valve is arranged in the hydraulic connection between the pressure chamber 4, 5 and the wheel brake 6a-6d. In this example, the front left 6a (FL) and rear right 6b (RR) wheel brakes are assigned to the first brake circuit I connected to the pressure chamber 4, the front right 6c (FR) and rear left 6d (RL) wheel brakes are assigned to the second brake circuit II. In this example, a check valve 43a, 43c opening in the direction of the wheel brake is connected in parallel to the first wheel valves 7a, 7c of the wheel brakes 6a, 6c of the front axle.

Furthermore, the first pressure chamber 4 is connected separably to the pressure medium storage container 9 by means of a hydraulic connection 33 with a discharge valve 25 which is advantageously normally closed. Thus the pressure chamber 4 can be switched “pressureless” even when the piston 2 is actuated, in that the pressure chamber 4 is connected to the pressure medium storage container 9 by the opening of the discharge valve 25.

The first master brake cylinder piston (primary piston) 2 which is mechanically coupled to the brake pedal is formed as a stepped piston with a circular face 24 and an annular face 23, wherein the circular face 24 delimits the first pressure chamber 4 and the annular face 23 delimits a hydraulic chamber 22. Here a pressure effect in the chamber 22 corresponds to a force which acts on the first master brake cylinder piston 2 against the actuation direction. According to the example, a return spring 28 is arranged in the chamber 22 and, in unactuated state, holds the primary piston 2 against a stop on the brake pedal side. The first pressure chamber 4 and the hydraulic chamber 22 are hydraulically sealed from each other, e.g. by a sealing element arranged on the housing 10 or on the piston 2.

The pressure chambers 4, 5 receive return springs (not shown in detail) which position the pistons 2, 3 in a starting position when the master brake cylinder 1 is not actuated. The return spring for the primary piston 2 rests on piston 3 in this example. Alternatively, a return spring for the primary piston 2 may be used which rests on the housing 10. The secondary chamber return spring is advantageously captive and fixed to the housing 10 and secondary piston 3.

A pushrod 20 couples the pivot movement of the brake pedal (not shown), as a result of pedal actuation, to the translation movement of the first (master brake cylinder) piston 2, the actuation travel of which is detected by a travel sensor 32, preferably configured redundantly. In this way, the corresponding piston travel signal is a measure of the brake pedal actuation angle. It represents a braking request by the vehicle driver.

The simulation device 11, which gives the vehicle driver a pleasant brake pedal feeling in brake-by-wire operating mode, substantially includes a hydraulic simulator chamber 12, a simulator spring chamber 14 with an elastic element 13, and a simulator piston 15 separating the two chambers 12, 14 from each other. The simulator chamber 12 is connected to the chamber 22 of the master brake cylinder 1 via a hydraulic connection 29a, and is connected separably to the brake medium storage container 9 via a hydraulic connection 29b with a normally open, e.g. analog or analog-controlled simulator valve 16. A check valve 17 opening in the direction of the chamber 22 is connected in parallel to the simulator valve 16.

When a brake pedal force is applied and the simulator valve (16) is actuated (closed), pressure medium flows from the chamber 22 of the master brake cylinder 1 into the simulator chamber 12, wherein the pedal feel thus generated depends on the counter-pressure built up by the elastic element 13. A pressure sensor 31 connected to the chamber 22 or simulator chamber 12 detects the pressure built up in the chamber 22 by the shift of the primary piston 2.

The electrically controllable pressurization device 18 is in this example formed as a hydraulic cylinder-piston arrangement or as a single-circuit electrohydraulic actuator, the piston 34 of which may be actuated by an electric motor 35 (indicated diagrammatically) with the interposition of a rotation-translation gear, also depicted diagrammatically. A rotor position sensor serving to detect the rotor position of the electric motor 35, and also indicated merely diagrammatically, is designated with reference numeral 36. In addition, a temperature sensor 37 may be used to detect the temperature of the motor winding. The piston 34 delimits a pressure chamber 38. A pressure medium connection 39 connected to the pressure medium storage container 9 leads, via a check valve 40 opening in this through-flow direction, to the pressure chamber 38 of the pressurization device 18. According to the example, the pressure chamber 38 is separably connected to all wheel brakes 6a-6d via a line 41 which transmits the system pressure output by the electrically controllable pressurization device 18. An electrically controllable, advantageously normally closed second wheel valve 8a-8d of the pressure-regulating valve arrangement is here assigned to each wheel brake 6a-6d, which valve is arranged in the hydraulic connection between the pressure chamber 38 and the wheel brake 6a-6d. According to the example, no further valve is arranged in the hydraulic connection between the pressure chamber 38 and the respective wheel brake 6a-6d. A pressure sensor 42, preferably designed redundantly, is connected to the line 41 to detect the system pressure.

On normal braking, in normal operating mode of the brake system (brake-by-wire operating mode), when the brake pedal is actuated by the vehicle driver, the primary piston 2 is actuated, wherein the piston movement is detected by the travel sensor 32. By means of the electronic control and regulating unit, the simulator valve 16 is closed and the discharge valve 25 is opened. In the (ring piston) chamber 22 of the primary piston 2, following the simulator curve of the simulation device 11, a pressure builds up which is measured with the pressure sensor 31 and can be used to detect the driver's request. Since, because of the open discharge valve 25, no pressure can build up in the (primary) pressure chamber 4, the only static counter-force is the simulator pressure force. A hydraulic damping effect may be achieved by the opening characteristic of the discharge valve 25. Thus damping values dependent on the primary piston travel can be implemented (hydraulically/mechanically and/or electronically). Due to the pressureless primary chamber 4, the secondary chamber 5 also remains pressureless or virtually pressureless (depending on the spring design of the return springs of the master brake cylinder). The normally open first wheel valves 7a-7d are closed and the normally closed wheel valves 8a-8d are opened, wherein this advantageously takes place slowly in order to reduce noise. By means of the pressurization device 18, by the shifting of the piston 34 by the electric motor 35, a system pressure is built up which leads to a wheel pressure build-up at the wheel brakes 6a-6d via line 41 when wheel valves 8a-8d are open. The system pressure or wheel pressure is measured by the pressure sensor 42.

When the brake pedal is released by the vehicle driver, the correspondingly smaller deceleration request is detected by means of travel sensor 32 and the piston 34 of the pressurization device 18 is retracted accordingly, whereby the (system) pressure and hence the wheel brake pressures diminish. The primary pressure chamber 4 fills with pressure medium from the pressure medium storage container 9 via the discharge valve 25 and via the sealing collars, where applicable via a check valve (not shown) in the discharge valve 25.

To perform a brake regulation individually for each wheel (e.g. ABS- or ESC-control (anti-lock braking system or electronic stability control system)), a pressure reduction at one wheel brake 6a-6d is achieved by opening the associated normally open wheel valve 7a-7d. Alternatively or at the same time, a pressure reduction can be achieved in multiplex mode by retracting the piston 34 of the pressurization device 18. The latter reduces the volume consumption or suction demand and allows a smaller volume of the pressure chamber 38. Pressure is built up again by opening the wheel valve 8a-8d and where applicable advancing the piston 34. Thus a volume control can take place easily and gently via the analog-controlled wheel valves 8a-8d. In addition, in multiplex mode, it is possible to measure the pressure in each wheel brake circuit by means of the pressure sensor 42.

An active brake pedal feedback or even a brake pedal return is possible by controlling the discharge valve 25 and the outflowing volume.

Due to the single-circuit structure in brake-by-wire mode, in particular for the use in assistance comfort functions or hybrid blending, the brake system offers the advantage that wheel brake circuits can be pressurized arbitrarily (e.g. front axle, rear axle, left wheels, right wheels only) by gentle control in the pressure regulation circuit without a secondary piston friction pressure difference.

A particularly rapid pressure build-up, as e.g. required for collision mitigation or prevention functions (collision mitigation by braking), can be achieved particularly favorably with the brake system according to the invention since the hydraulic resistance on the path to the wheel valves consists only of one wheel valve per wheel brake.

In a fallback operating mode of the brake system (fallback level), the simulator valve 16 remains open and the discharge valve 25 remains closed. The normally open wheel valves 7a-7d remain open. On actuation of the brake pedal by the vehicle driver, pressure medium is moved from the chamber 22 via the opened simulator valve 16 into the pressure medium storage container 9. Because the simulation device is hydraulically isolated from the pressure chambers 4, 5 of the master brake cylinder 1, the vehicle driver can build up a pressure in the pressure chambers 4, 5 so that a pressure build-up takes place in the wheel brakes 6a-6d via the lines 27a, 27b by the vehicle driver. An emergency EBD (electronic brake force distribution) on the rear axle is possible in that e.g. the wheel valves 7a and 7b are closed prematurely by a blocking tendency.

On transition to fallback level, by the closure of the discharge valve 25, the brake system offers a direct, gap-free—i.e. without loss of brake pedal travel—actuation of the wheel brakes, since the pressure medium volume displaced by the vehicle driver is still only discharged at the wheel brakes.

In fallback operating mode, via the check valves 43a, 43c, pressure medium can be pressed directly into the wheel circuits 6a, 6b even when the wheel valves 7a, 7c are closed.

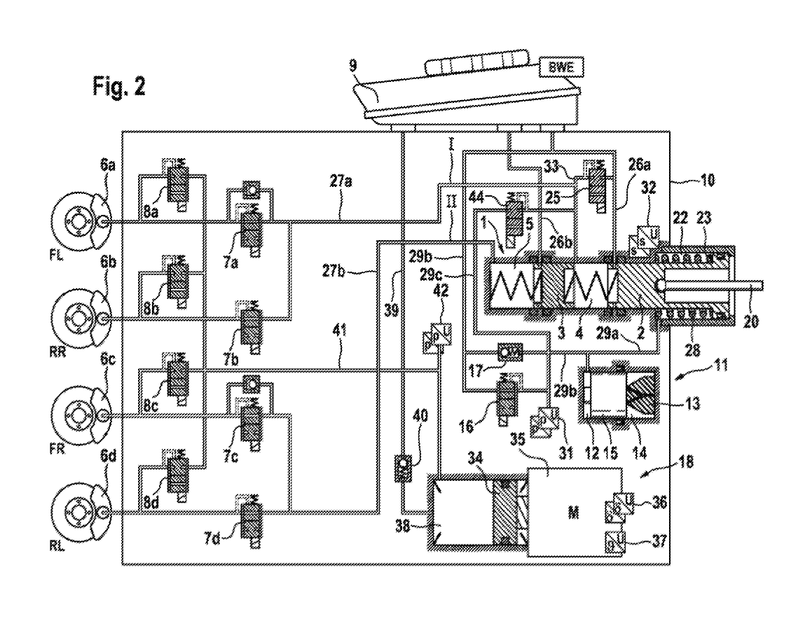

FIG. 2 shows a second exemplary embodiment of a brake system according to the invention. The second exemplary embodiment corresponds to the first exemplary embodiment, wherein additionally a hydraulic connection can be created between the chamber 22 and the pressure chamber 4. For this, a line 29c is present in which an electrically actuatable, normally closed prefill valve 44 is arranged.

The prefill valve 44 allows an intermediate fallback level in which, up to a specific pressure, pressure medium volume is conducted to the primary pressure chamber 4 from the (ring piston) chamber 22. For this, the prefill valve 44 is opened and the simulator valve 16 is closed. The pedal travel is shortened in this intermediate fallback level.

The prefill valve 44 also improves the analysis of fault possibility and influence of the brake system, since a redundant hydraulic path is available through the line 29c with prefill valve 44 if the discharge valve 25 or simulator valve 16 is overloaded.

As an alternative to the pressurization device 18 shown in FIGS. 1 and 2 in the form of a single-circuit electrohydraulic actuator (linear actuator), the brake system according to the invention may also comprise a unidirectional, advantageously pulsation-free delivery pump, driven by means of an electric motor, as a pressurization device (not shown in a figure). The pressure port of the pump is connected to the line 41 and the suction port to the check valve 40. Such a motor—pump assembly offers the advantage of not requiring a high reversibility of the motor—pump assembly and further intake of pressure medium. Furthermore, a compact construction is possible.

In the brake-by-wire operating mode, pressure is built up via the pump. Pressure is reduced when the pump is stopped and the wheel valves 8a-8d are opened in the pressure-balanced pressure regulating circuit 41 (depicted with pressure sensor 42) via the analog-controlled wheel valves 7a-7d.

The pressure sensor 42 of the pressurization device may be omitted if the current of the brushless electric motor of the pressurization device is measured sufficiently precisely, and from this the system pressure concluded. Using calibrated wheel valves 7, 8, e.g. in the brake system itself, it is possible to set the pressure at the wheel brakes sufficiently precisely. Furthermore, the wheel rotation speed information of the wheels assigned to the wheel brakes may be used for a plausibility check of a pressure model for the system pressure.

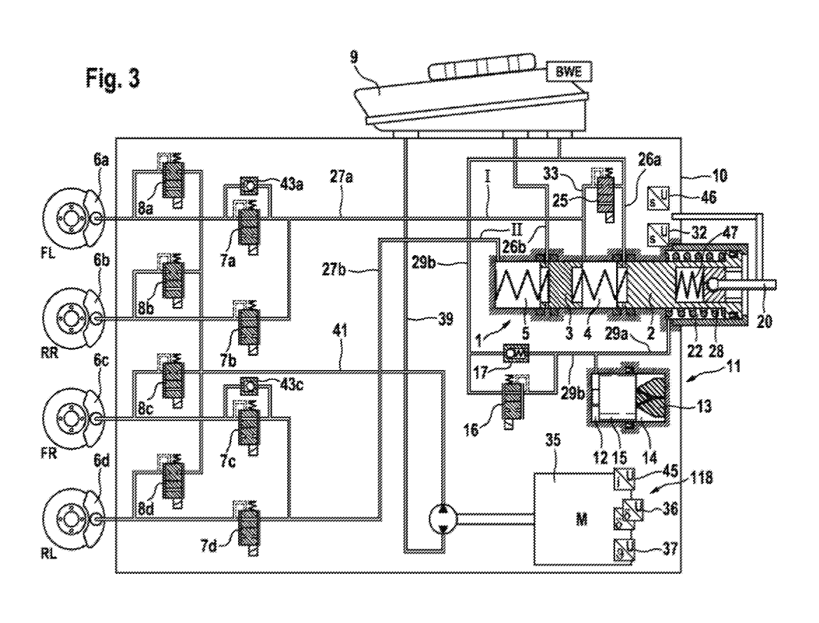

Accordingly, FIG. 3 shows a third exemplary embodiment of a brake system according to the invention which has no pressure sensor in the line 41 of the pressurization device 118. The pressure sensor has been replaced by a current measurement of the brushless electric motor 35 of the pressurization device 118 by means of the current sensor 45. The hydraulic structure of the third exemplary embodiment corresponds in principle to that of the first exemplary embodiment, so in the description below only the differences from the first exemplary embodiment will be discussed. The pressurization device 118 is formed as a bidirectional, advantageously pulsation-free delivery pump driven by means of an electric motor, by means of which pump a pressure build-up and pressure reduction can be carried out directly at the wheel brakes 6a-6d. For this, the pump 118 with its two ports is connected to the line 41 to the wheel brakes, and the line 39 (without check valve 40 from FIG. 1) is connected to the pressure medium storage container 9. The pressurization device 118 offers the advantage that no further intake of pressure medium is required and a compact construction is possible.

Furthermore, the brake system according to the example does not contain a pressure sensor in the line 29b of the simulation device 11. To determine the pressure of the simulation device, a double travel sensor 32, 46 may be used, in which one travel sensor detects a movement of the piston 2 and a second travel sensor detects a movement of the piston rod 20. The interposition of a spring element 47 allows conclusion of the actuation force from the differential travel and the stiffness of the spring element. At the same time, the two travel sensors (double travel sensor) monitor each other. In this way, the costs of the brake system can be reduced. However this also allows sensing of an undesirable counter-force via a pressure effect in the primary pressure chamber 4 (e.g. if discharge valve 25 is undesirably closed).

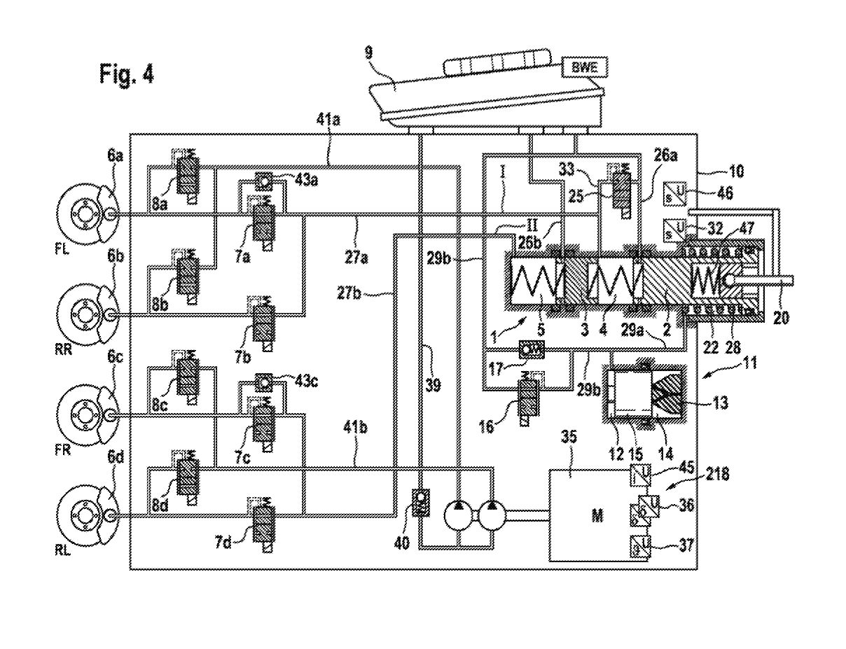

FIG. 4 shows a fourth exemplary embodiment of a brake system according to the invention. The fourth exemplary embodiment corresponds to the third exemplary embodiment, wherein the pressurization device is configured differently. The pressurization device 218 is formed as a dual-circuit, unidirectional, advantageously pulsation-free delivery pump driven by means of a common electric motor 35. The two suction ports of the pump are connected via the check valve 40 to the pressure medium storage container 9, the one pressure port of the pump is connected via the line 41a to the second wheel valves 8a, 8b of the wheel brakes 6a, 6b of the first brake circuit I, and the other pressure port of the pump is connected via the line 41b to the second wheel valves 8c, 8d of the wheel brakes 6c, 6d of the second brake circuit II. Such a motor-pump assembly offers the advantage of a clear circuit separation. Here again, no high reversibility of the motor-pump assembly is required, nor further intake of pressure medium. Furthermore, a compact construction is possible.

Pressure is built up by the pump in brake-by-wire operating mode. Pressure is reduced when the pump is stopped and the wheel valves 8a-8d are opened in the pressure-balanced pressure regulating circuit 41 (for this, advantageously a pressure sensor may be provided for each line 41a, 41b) via an analog-controlled first wheel valve 7a-7d per wheel brake.

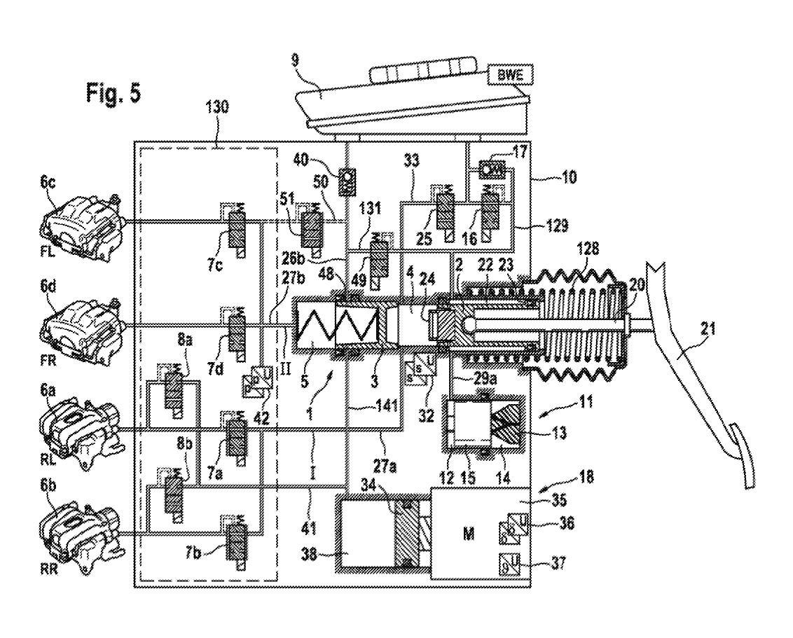

FIG. 5 shows a fifth exemplary embodiment of a brake system according to the invention which substantially consists of a hydraulic master brake cylinder 1 which can be actuated by means of an actuation or brake pedal 21, a hydraulically actuatable simulation device 11 cooperating with the master brake cylinder 1, a pressure medium storage container 9 assigned to the master brake cylinder 1, an electrically controllable pressurization device 18, hydraulically actuatable wheel brakes 6a-6d, an electrically controllable pressure-regulating valve arrangement 130 for regulating and/or controlling the wheel brake pressures set at the wheel brakes, and an electronic control and regulating unit (ECU) not shown.

The master brake cylinder 1 has in a housing 10 two hydraulic master brake cylinder pistons 2, 3 arranged one behind the other, which together with the housing 10 delimit hydraulic pressure chambers 4, 5. The first master brake cylinder piston (primary piston) 2 coupled via a pushrod 20 to the brake pedal 21 is formed as a stepped piston with a circular face 24 and an annular face 23, wherein the circular face 24 delimits the first pressure chamber 4 and the annular face 23 delimits a hydraulic chamber 22. A pressure effect in the chamber 22 corresponds to a force which acts on the first master brake cylinder piston 2 against the actuation direction. In this example, a return spring 128 is effectively arranged between the housing 10 and the brake pedal 21, and positions the brake pedal 21 and hence the primary piston 2 in a starting position when the brake pedal is not actuated. The pressure chamber 5 receives a return spring (not shown in detail) which positions the piston 3 in a starting position when the master brake cylinder 1 is not actuated. The return spring is advantageously fixed to the housing 10. The actuation travel of the master brake cylinder piston 2 is detected by a travel sensor 32, preferably formed redundantly, and represents the vehicle driver's braking request.

The pressure chambers 4, 5 are connected to the pressure-regulating valve arrangement 130 by means of hydraulic lines 27a, 27b. According to the example, the pressure-regulating valve arrangement 130 includes a normally open first wheel valve 7a-7d for each wheel brake 6a-6d, and a normally closed second wheel valve 8a, 8b for the wheel brakes 6a, 6b assigned to the primary pressure chamber 4. The wheel valves 7a and 7b are in this example analog or analog-controllable. The wheel valves 7a-7d are arranged in the respective hydraulic connection between the pressure chamber 4, 5 and the wheel brake 6a-6d, wherein according to the example, no further valve is arranged in this connection. In the example, the rear wheel brakes (6a: rear left (RL), 6b: rear right (RR)) are assigned to the first brake circuit I connected to the pressure chamber 4, and the front wheel brakes (6c: front left (FL), 6d: front right (FR)) are assigned to the second brake circuit II.

Radial bores are formed in each of the master brake cylinder pistons 2, 3. When the master brake cylinder piston 3 is not actuated, the pressure chamber 5 is connected to the pressure chamber 38 of the pressurization device 18 via the radial bores and a connection 141, and to the pressure medium storage container 9 via the radial bores, the container port 48 and a line 26b with a check valve 40. The check valve is arranged opening in the direction from the pressure medium storage container 9 to the pressure chamber 5, so that pressure medium can be drawn out of the pressure medium storage container 9, via the connection 26b, the pressure chamber 5 and the connection 141, into the pressurization device 18. When the master brake cylinder piston 2 is not actuated, the pressure chamber 4 is connected to the chamber 22 via the radial bore. The connection via the radial bores is blocked by an actuation (movement) of the piston 2 or 3 in the housing 10. The first pressure chamber 4 and the hydraulic chamber 22 are thus hydraulically sealed from each other when the first master brake cylinder piston is in the actuated state.

Furthermore, the first pressure chamber 4 is separably connected to the pressure medium storage container 9 by means of a hydraulic connection 33 with an advantageously normally closed discharge valve 25. Thus the pressure chamber 4 can be switched “pressureless” even when the piston 2 is in the actuated state, in that the pressure chamber 4 is connected to the pressure medium storage container 9 by the opening of the discharge valve 25. Furthermore, the surplus pressure medium volume which must be dissipated from the wheel brakes 6a, 6b into the pressure medium storage container 9 on braking regulation (e.g. slip control) can be discharged via the discharge valve 25 into the pressure medium storage container.

The simulation device 11 substantially corresponds to the simulation device described in detail with reference to FIG. 1. The simulator chamber 12 is connected to the chamber 22 of the master brake cylinder 1 via a hydraulic connection 29a. The chamber 22 is separably connected to the pressure medium storage container 9 via a hydraulic connection 129 with a normally open simulator valve 16. A check valve 17 opening in the direction of the chamber 22 is connected in parallel to the simulator valve 16. The effect of the simulation device 11 can be switched on and off by the simulator valve 16.

In the example, furthermore the container port 48 of the secondary pressure chamber 4 is connected via a hydraulic connection to the chamber 22 and hence to the simulator chamber 12, wherein the connection can be separated by a second, advantageously normally open, isolating valve 49. In the example, the isolating valve 49 is arranged in a line portion 131 which connects the line 26b to the line portion between the chamber 22 and the simulator valve 16 (connection 129).

When a brake pedal force is applied and the simulator valve 16 is closed and the container-isolating valve 49 is closed, pressure medium flows from the chamber 22 of the master brake cylinder 1 into the simulator chamber 12, wherein the pedal feel thus generated is substantially determined by the elastic element 13.

The electrically controllable pressurization device 18 formed as a single-circuit electrohydraulic actuator substantially corresponds to the pressurization device explained in detail with reference to FIG. 1. The pressure chamber 38 of the pressurization device 18 is connected firstly via a line 41 to the wheel brakes 6a, 6b of the first brake circuit I, in each case via a normally closed second wheel valve 8a, 8b of the pressure-regulating valve arrangement 130. In this example, no further valve is arranged in the hydraulic connection between the pressure chamber 38 and the respective wheel brake 6a, 6b. Secondly, the pressure chamber 38 is connected to the pressure chamber 5 via the hydraulic connection 141 when the secondary piston 3 is not actuated, so that in brake-by-wire operating mode, the wheel brakes 6a, 6b can be pressurized by the pressurization device 18.

As well as the travel sensor 32 to detect the braking request and the sensor 36 to detect a position of the pressurization device 18, the brake system according to the example includes a pressure sensor 42, preferably designed redundantly, by means of which the system pressure of the pressurization device 18 is detected in brake-by-wire operating mode.

Optionally (indicated by the dotted line portion 50), a separable hydraulic connection is provided between the connection 27b and the pressure medium storage container 9, bypassing the check valve 40. In the example, for this a line portion 50 with a normally closed sequence valve 51 is arranged between the lines 27b and 26b (between container port 48 and check valve 40). Alternatively, the normally closed sequence valve 51 may be arranged parallel to the check valve 40 (i.e. in a line which bypasses the check valve), as shown in the seventh exemplary embodiment explained below. In this way, the pressure reduction at the wheel brakes 6c and 6d can take place very quickly and the requirements for the reversing dynamic of the pressurization device 18 can be reduced.

The brake system according to the example offers the advantage that it only uses nine or ten valves.

On normal braking, in normal operating mode of the brake system (brake-by-wire operating mode), when the brake pedal 21 is actuated by the vehicle driver, the primary piston 2 is actuated, wherein the piston movement is detected by the travel sensor 32. By means of the electronic control and regulating unit, the simulator valve 16 and the isolating valve 49 are closed and the discharge valve 25 opened. A pressure builds up in the chamber 22 of the primary piston 2 following the simulator curve of the simulator device 11. Since, because of the open discharge valve 25, no pressure can build up in the (primary) pressure chamber 4, the only static counter-force is the simulator pressure force. A hydraulic damping effect is possible via the opening characteristic of the discharge valve 25, as already described with reference to FIG. 1. Due to the pressureless primary chamber 4, the secondary chamber 5 also remains pressureless or virtually pressureless. The normally open wheel valves 7c, 7d of brake circuit II remain open, while the normally open wheel valves 7a, 7b of brake circuit I are closed. The normally closed wheel valves 8a, 8b of brake circuit I are opened. By means of the pressurization device 18, by shifting of the piston 34 by the electric motor 35, a system pressure is built-up which leads via the line 41 or the hydraulic connection 141, 4, 27b, to a wheel pressure build-up at the wheel brakes 6a-6b. The system pressure or wheel pressure is measured by pressure sensor 42.

When the brake pedal is released by the vehicle driver, the correspondingly lower deceleration request is detected by the travel sensor 32 and the piston 34 of the pressurization device 18 is retracted accordingly, whereby the wheel brake pressures are reduced via the (open) multiplex wheel valves 7c, 7d in brake circuit II (in this example, the front axle circuit) and via the opened second wheel valves 8a, 8b in brake circuit I (in this example, the rear axle circuit).

The brake system shown in the example offers a number of diagnostic possibilities which will be explained below.

A leakage at wheel valves 7a-7d, wheel valves 8a, 8b, the outer collar of the simulation device and the simulator (outer) collar, can be detected by closing the first wheel valves 7a-7d and the simulator valve 16 and building up the pressure, then maintaining the pressure by means of the pressurization device 18. Any pressure fall due to leakage can be detected by the pressure sensor 42. An air inflow into chambers 4, 5, 22 of the master brake cylinder or the simulator chamber 12 can be detected by closing the first wheel valves 7a-7d and the simulator valve 16, and performing a slow pressure build-up by the pressurization device 18. The volume-pressure curve is measured by the sensor 36 (actuator travel) and pressure sensor 42, and compared with a predefined nominal simulator curve.

A leakage at the first wheel valves 7a-7d, the isolating valve, the seal of the secondary pressure chamber 5 or the collar of the pressurization device 18, can be detected by closing the wheel valves 7a-7d and the isolating valve 49, then building up the pressure and then maintaining the pressure by means of the pressurization device 18. Any pressure fall due to leakage can be detected by the pressure sensor 42.

The movement capacity of the piston 3 can be tested if the valves 7a-7d and the simulator valve 16 are closed, and a pressure build-up carried out (by means of the pressurization device 18) with pre-tensioning of the simulation device 11. Then the isolating valve 49 is closed and the pressure reduced by means of the pressurization device 18. The movement of the piston 3 is detected by observing the simulator pressure at the pressure sensor 42, since after the pressure fall, the pressurized simulator 11 moves the piston 3 if the system is intact, which in turn leads to a pressure build-up in the chamber 5.

A leakage at the seal of the primary pressure chamber 4 can be detected and a corresponding message sent to the driver (OK/NOK) on each driver actuation, since this seal acts on both sides.

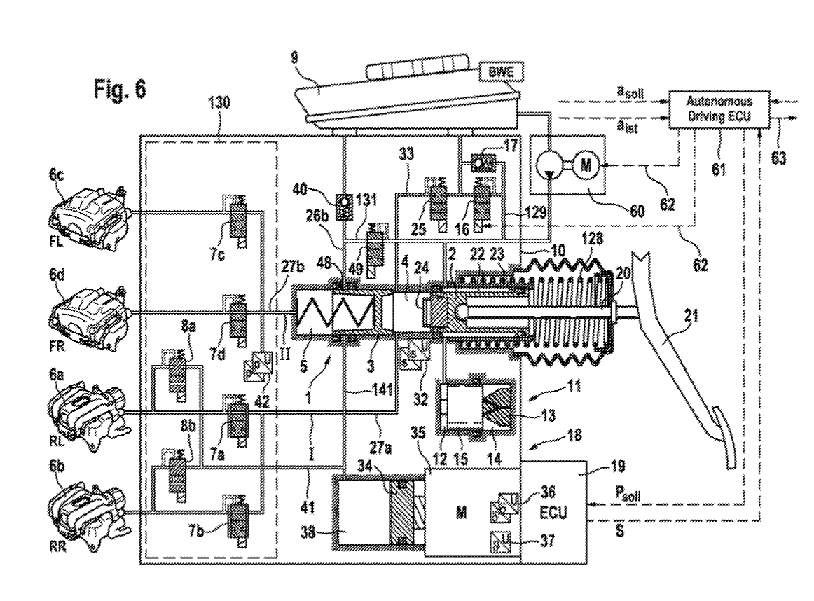

FIG. 6 shows diagrammatically a sixth exemplary embodiment of a brake system according to the invention. In contrast to the exemplary embodiment described with reference to FIG. 5, the brake system furthermore includes a second pressurization device 60 and a further electronic control and regulating unit 61. These additional components allow autonomous driving.

The second pressurization device 60 is advantageously configured as an autonomous module. In this example, the pressurization device 60 is formed by a motor-pump assembly, wherein the suction side of the pump is connected to the pressure medium storage container 9, and the pressure side of the pump is connected to the hydraulic connection 129.

The control and regulating unit 61 is configured to control the second pressurization device 60 and the simulator valve 16 (control lines 62 indicated diagrammatically in FIG. 6), in order to be able to perform a pressure build-up in chamber 22 independently of actuation of the brake pedal 21 by the vehicle driver. To allow autonomous driving, at least one nominal longitudinal acceleration value aₛₒᵢₗ and one actual longitudinal acceleration value aᵢₛₜ are supplied to the control and regulating unit 61. Furthermore, the control and regulating unit 61 is connected to the control and regulating unit 19 of the brake system for exchanging information. Thus e.g. the nominal pressure Pₛₒₗₗ for the pressurization device 18 is transmitted from the control and regulating unit 61 to the control and regulating unit 19, and the control and regulating unit 19 transmits a status signal S (e.g. for its function capability) to the control and regulating unit 61. In addition in this example, the control and regulating unit 61 exchanges information with a drive motor or its control and regulating unit, as indicated in FIG. 6 by arrows 63.

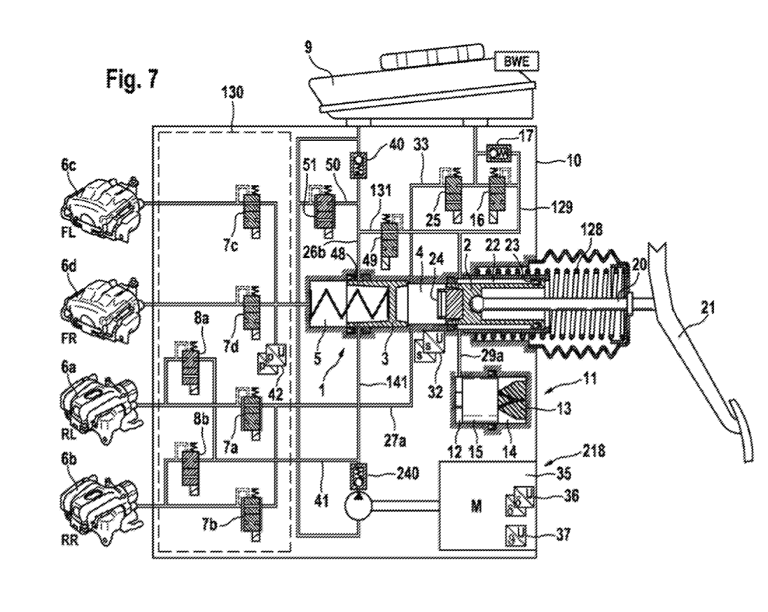

According to the seventh exemplary embodiment shown in FIG. 7, which corresponds to the fifth exemplary embodiment apart from the differences explained below, the brake system includes a pressurization device 218 in the form of a unidirectional delivery pump driven by means of an electric motor 35, the pressure side of which is connected to lines 41 and 141 via a check valve 240 opening in the direction of lines 41, 141, and the suction side of which is hydraulically connected to the pressure medium storage container 9. Also, in the example the brake system includes a normally closed sequence valve 51 arranged in parallel to the check valve 40.

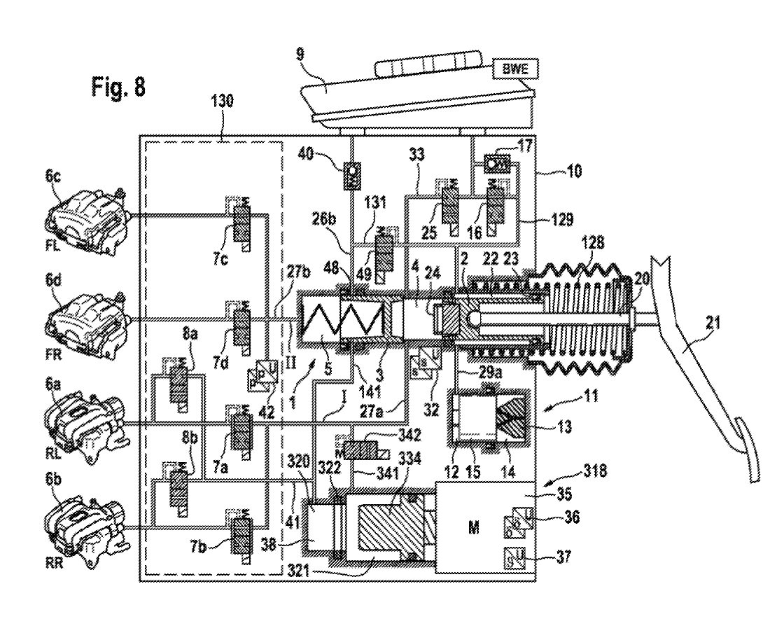

The eighth exemplary embodiment of a brake system according to the invention shown in FIG. 8 corresponds to the fifth exemplary embodiment apart from the differently configured, electrically controllable pressurization device and its connection. The pressurization device 318 in this example is configured as a hydraulic cylinder-piston arrangement, the piston 334 of which, driven by the electric motor 35, is formed as a stepped piston. The stepped piston 334 and the cylinder of the cylinder-piston arrangement are configured such that, after a predefined actuation travel of the piston 334, the pressure chamber 38 of the pressurization device 318 is divided into a first chamber 320 and a second chamber 321, wherein the second chamber 321 is a ring chamber. The first chamber 320 and the second chamber 321 are then sealed against each other by second sealing element 322, wherein the second chamber 321 is sealed against atmospheric pressure by a sealing element not shown in detail (as also in the exemplary embodiments of FIGS. 1, 2, 5, 6). In the region of the first chamber 320, the pressure chamber 38, as in the fifth exemplary embodiment, is connected via a line 41 to the normally closed wheel valves 8a, 8b of the brake circuit II and via line 141 to the pressure chamber 5. In addition, the pressure chamber 38 in the region of the second chamber 321 is connected to the line 27a via a line portion 341 with a normally closed valve 342. In this way, in brake-by-wire operating mode with the discharge valve 25 opened, the second chamber 321 can be connected to a pressure medium storage container 9. As a result, for the further pressure build-up by the motor 35, only the pressure effect on the small active face of the piston need be overcome, which leads to a reduction in the necessary drive moment. Thus the motor 35 may be made smaller for the same dynamic and hence designed to save weight and cost. As an alternative to the electrically driven valve 342, the switching can take place by a hydraulic changeover valve (not shown here), wherein the switching takes place in that the pressure in the chamber 38 can press the valve body against the container pressure effect (atmospheric pressure) and the force effect of a spring, the pretension of which defines the changeover pressure (e.g. 120 bar), so that the chamber 321 is connected to the container pressure. In the case of a leak in the sealing element which seals the second chamber 238 against atmospheric pressure, after overcoming the predefined actuation travel of the piston 334, the first chamber 320 is sealed by the sealing element 322 which then comes into effect, so that nonetheless a pressure build-up is possible at the wheel brakes 6a-6d by means of the pressurization device 318. This is important in particular for use of the brake system for the functions of highly automated driving, since the occurrence of a single fault—such as failure of the sealing collar—must not lead to total failure of the brake system, because in this case the driver is practically unavailable to perform the braking by means of the hydraulic fallback level.

Various advantageous exemplary embodiments in relation to the pressure-regulating valve arrangement and/or the brake circuit division are described below. The exemplary embodiments relate to a brake system which substantially corresponds to the fifth exemplary embodiment in relation to the components of the master brake cylinder 1, simulation device 11, pressurization device 18, valves 16, 25, 49 and their hydraulic connections. The pressure-regulating valve arrangements and/or the brake circuit divisions described may however also be used in combination with one of the other exemplary embodiments already described (in particular that of FIGS. 6 to 8).

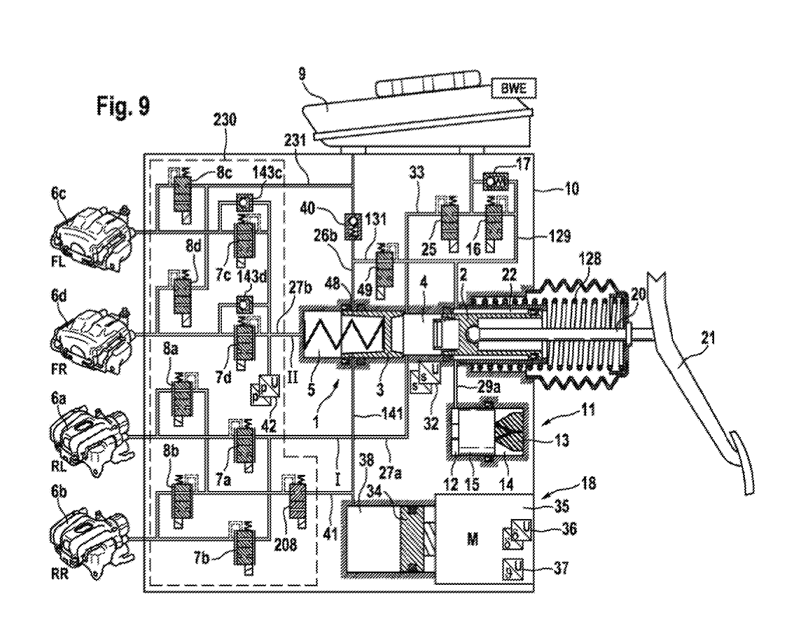

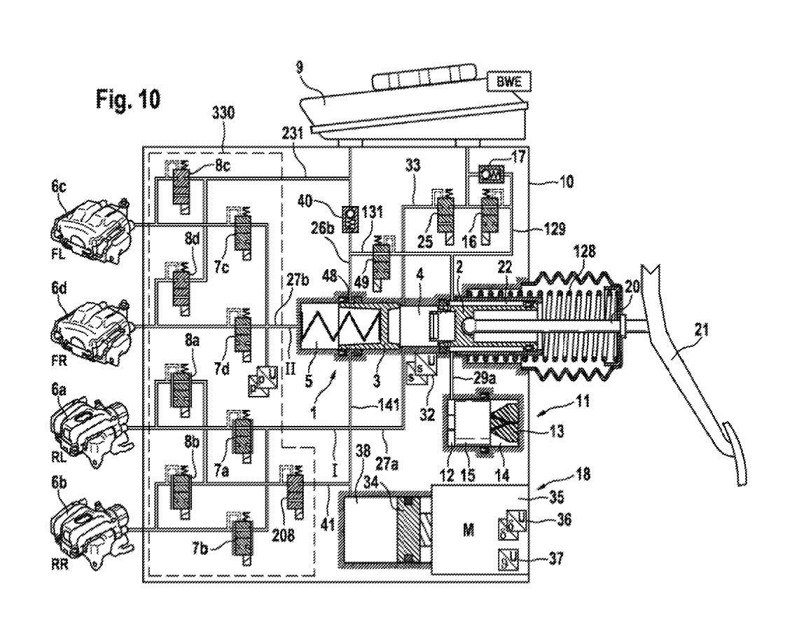

The ninth exemplary embodiment shown in FIG. 9 and the twelfth exemplary embodiment shown in FIG. 10 of a brake system according to the invention have a black-white circuit division like the fifth exemplary embodiment, i.e. the wheel brakes of one vehicle axle 6a, 6b (RL, RR) or 6c, 6d (FL, FR) are assigned to one brake circuit I or II respectively.

According to the ninth exemplary embodiment of FIG. 9, the pressure-regulating valve arrangement 230 for the front axle (brake circuit II) includes, for each wheel brake 6c, 6d, a normally open analog or analog-controllable (first) wheel valve 7c, 7d-wherein a check valve 143c, 143d closing in the direction of the wheel brake 6c, 6d is connected in parallel to each wheel valve 7c, 7d—and a normally closed (second) wheel valve 8c, 8d. The first wheel valves 7c, 7d are arranged in the respective hydraulic connection between the pressure chamber 5 and the wheel brake 6c, 6d. Each wheel brake 6c, 6d may be connected to the pressure medium storage container 9 via the second wheel valves 8c, 8d (return line 231). For the rear axle (brake circuit I), the pressure-regulating valve arrangement 230 includes, for each wheel brake 6a, 6b, a normally open, analog or analog-controllable (first) wheel valve 7a, 7b, via which the pressure chamber 4 is separably connected to the respective wheel brake 6a, 6b, and a normally open, analogue or analog-controllable (second) wheel valve 8a, 8b, via which the pressure chamber 38 of the pressurization device 18 is separably connected to the respective wheel brake 6a, 6b, wherein a further normally closed circuit valve 208 is arranged in the connection (line 41). The valve configuration shown in FIG. 9 is particularly advantageous in that the pressure build-up can take place very gently per individual wheel, and the pressure reduction can be set very rapidly per individual wheel, whereby also the requirements for the reversing dynamic of the motor are reduced.

According to a tenth exemplary embodiment (not shown), the pressure-regulating valve arrangement advantageously includes, for the front axle, a valve arrangement as shown in FIG. 9 for the front axle (normally open, analog or analog-controllable wheel valves 7c, 7d with check valves 143c, 143d and normally closed wheel valves 8c, 8d), and for the rear axle a valve arrangement as shown in FIG. 5 for the rear axle (normally open, analog or analog-controllable wheel valves 7a, 7b and normally closed wheel valves 8a, 8b).

According to an eleventh exemplary embodiment (not shown), the pressure-regulating valve arrangement advantageously includes, for the rear axle, a valve arrangement as shown in FIG. 5 for the rear axle (normally open, analog or analog-controllable wheel valves 7a, 7b and normally closed wheel valves 8a, 8b). For the front axle, the pressure-regulating valve arrangement includes a valve arrangement similar to that shown in FIG. 9 for the front axle, with normally open wheel valves 7c, 7d and normally closed wheel valves 8c, 8d, wherein however the valves 7c, 7d are not analog or analog-controllable and there are no parallel-connected check valves. This pressure-regulating valve arrangement thus corresponds to the pressure-regulating valve arrangement 130 of FIG. 5, but with additional normally closed wheel valves 8c, 8d for the front wheels.

According to the twelfth exemplary embodiment of FIG. 10, the pressure-regulating valve arrangement 330 includes, for the rear axle, a valve arrangement as shown in FIG. 9 for the rear axle (normally open, analog or analog-controllable wheel valves 7a, 7b, 8a, 8b, and a normally closed circuit valve 208). For the front axle, the pressure-regulating valve arrangement 330 includes a valve arrangement according to the eleventh exemplary embodiment described above, with normally open digital wheel valves 7c, 7d and normally closed wheel valves 8c, 8d which connect the wheel brakes 6c, 6d to the pressure medium storage container 9 via return line 231 when required.

According to a thirteenth exemplary embodiment (not shown), the pressure-regulating valve arrangement advantageously includes, for the front axle, a valve arrangement as shown in FIG. 5 for the front axle (normally open wheel valves 7c, 7d) and for the rear axle, a valve arrangement as shown in FIG. 9 for the rear axle (normally open, analog or analog-controllable wheel valves 7a, 7b, 8a, 8b, and a normally closed circuit valve 208).

According to a fourteenth exemplary embodiment (not shown), the pressure-regulating valve arrangement advantageously includes, for the front axle, a valve arrangement as shown in FIG. 5 for the front axle (normally open wheel valves 7c, 7d) and for the rear axle, a valve arrangement as shown in FIG. 9 for the rear axle with normally open, analog or analog-controllable first wheel valves 7a, 7b, wherein however the normally open second wheel valves 8a, 8b are digital and the normally closed circuit valve 208 is analog or analog-controllable.

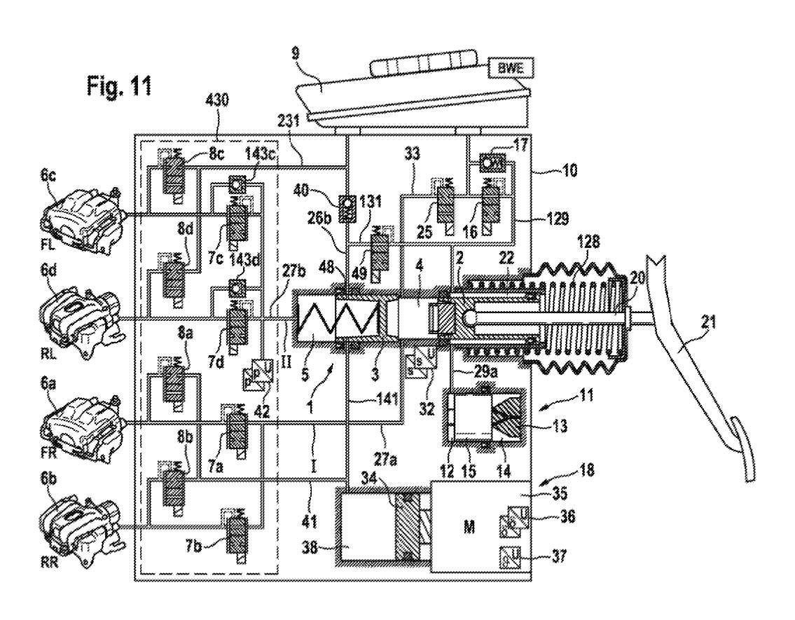

According to the fifteenth exemplary embodiment of a brake circuit according to the invention shown in FIG. 11, the wheel brakes 6a and 6b of brake circuit I are assigned to the right vehicle side (front right wheel FR and rear right wheel RR), and the wheel brakes 6c, 6d of brake circuit II are assigned to the left vehicle side (front left wheel FL and rear left wheel RL). The pressure-regulating valve arrangement 430 includes, for each wheel brake 6a-6d, a normally open, analog or analog-controlled first wheel valve 7a-7d which is arranged in the hydraulic connection between the pressure chamber 4, 5 and the wheel brake 6a-6d. A check valve 143c, 143d closing in the direction of the wheel brake 6c, 6d is connected in parallel to each wheel valve 7c, 7d. Furthermore, the pressure-regulating valve arrangement 430 includes, for each wheel brake 6a-6d, a normally closed, analog or analog-controlled second wheel valve 8a-8d, wherein the wheel valves 8a, 8b are arranged in the hydraulic connection between the pressure chamber 38 of the pressurization device 18 and the respective wheel brake 6a, 6b, and the wheel valves 8c, 8d are arranged in the respective hydraulic connection between the wheel brake 6c, 6d and the pressure medium storage container 9.

According to a sixteenth exemplary embodiment (not shown), the pressure-regulating valve arrangement advantageously includes a brake circuit division and a valve arrangement as shown in FIG. 11, wherein however only two of the eight wheel valves 7a-7d, 8a-8d—in this example, the wheel valves 7d and 8b—are analog or analog-controllable, and the remainder of the eight valves are configured digitally.

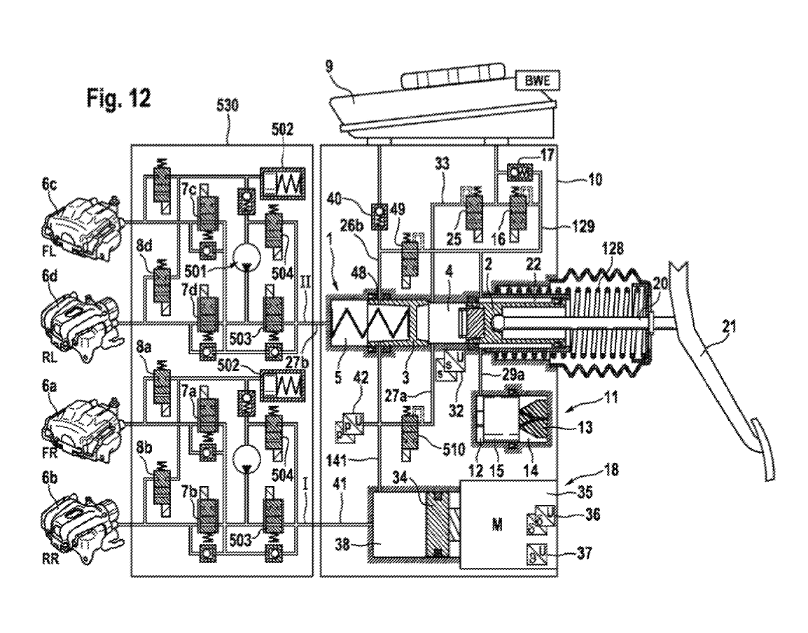

FIG. 12 shows a seventeenth exemplary embodiment of a brake system according to the invention which substantially corresponds to the fifth exemplary embodiment (FIG. 5) with regard to the components of the master brake cylinder 1 actuatable by means of a brake pedal 21, the simulation device 11, the pressure medium storage container 9, the pressurization device 18, the valves 16, 25, 49 and 40, and the sensor 32. The pressure sensor 42 according to the example is arranged on the line portion 141, i.e. close to the pressure chamber 38 of the pressurization device 18. The components are arranged in the housing 10. Furthermore, the brake system includes a hydraulic regulating unit 530 known in itself, as known from conventional brake systems with electronic stability control (standard ESC brake systems), and which includes a dual-circuit motor-pump assembly 501 with a low-pressure accumulator 502 for each brake circuit I, II, a normally open wheel valve 7a-7d and a normally closed wheel valve 8a-8d per wheel brake 6a-6d, a normally closed isolating valve 503 and a normally closed changeover valve 504 per brake circuit I, II. The wheel brakes 6a-6d are connected to the hydraulic regulating unit 530 and assigned to the brake circuits I, II on the vehicle side. The pressurization device 18 is connected by means of the line 41 to the first port of the hydraulic regulating unit 530 for brake circuit I, the secondary pressure chamber 5 of the master brake cylinder 1 is connected by means of the line 27b to the second port of the hydraulic regulating unit 530 for brake circuit II. The primary pressure chamber 4 of the master brake cylinder 1 is separably connected by means of line 27a to the line portion 141 between the pressure chamber 38 and the pressure chamber 5, wherein separation is possible electrically through a normally open isolating valve 510.

While the above description constitutes the preferred embodiment of the present invention, it will be appreciated that the invention is susceptible to modification, variation and change without departing from the proper scope and fair meaning of the accompanying claims.

1. A brake system for motor vehicles which can be controlled in a brake-by-wire operating mode both by a vehicle driver and independently of the vehicle driver, comprising;
a master brake cylinder which has at least a first and a second master brake cylinder piston which are arranged one behind the other and delimit a first and a second pressure chamber, to each of which a brake circuit with wheel brakes is connected, wherein the first master brake cylinder piston is coupled to a brake pedal via a pushrod transmitting an actuating force, a pressure medium storage container under atmospheric pressure which is assigned to the first and second pressure chambers,
a hydraulically actuatable simulation device with a hydraulic simulator chamber and an elastic element which, in the brake-by-wire operating mode, gives the vehicle driver a pleasant brake pedal feeling,
an electrically actuatable simulator valve, for switching the effect of the simulation device on and off,
an electrically controllable pressurization device for actuating the wheel brakes, and
a pressure-regulating valve arrangement hydraulically connected to the master brake cylinder, the pressurization device and the wheel brakes, for regulating or controlling a wheel brake pressure set at the wheel brake, wherein a first electrically controllable, normally open wheel valve of the pressure-regulating valve arrangement is assigned to each wheel brake,
the first master brake cylinder piston is formed as a stepped piston, the annular face of which delimits a hydraulic chamber, wherein the hydraulic chamber is hydraulically connected to the simulator chamber.

2. The brake system as claimed in claim 1, further comprising in that a hydraulic connection is provided between the first pressure chamber and the pressure medium storage container, in which connection an electrically actuatable normally closed discharge valve is arranged.

3. The brake system as claimed in claim 1 further comprising in that the simulator valve is configured normally open.

4. The brake system as claimed in claim 1 further comprising in that a hydraulic connection is provided between the hydraulic chamber and the pressure medium storage container, in which connection the simulator valve is arranged.

5. The brake system as claimed in claim 1 further comprising in that the first wheel valve is arranged in the connection between the wheel brake (6a-6d) and the first or the second pressure chamber, wherein no further valve is arranged in the connection between the first wheel valve and the first or second pressure chamber.

6. The brake system as claimed in claim 1 comprising in that a hydraulic connection is provided:
between the second pressure chamber and the hydraulic chamber, or
between the second pressure chamber and the simulator chamber, in which connection an electrically actuatable normally open isolating valve is arranged.

7. The brake system as claimed in claim 6, further comprising in that the connection is blocked by actuation of the second master brake cylinder piston.

8. The brake system as claimed in claim 1 further comprising in that at least one radial bore is arranged in the first master brake cylinder piston, such that when the first master brake cylinder piston is not actuated, the first pressure chamber is connected to the hydraulic chamber via the radial bore, wherein the connection is blocked by actuation of the first master brake cylinder piston.

9. The brake system as claimed in claim 1 further comprising in that a hydraulic connection is provided between the pressurization device and the second pressure chamber, which connection is blocked by actuation of the second master brake cylinder piston.

10. The brake system as claimed in claim 1 further comprising in that a second electrically controllable wheel valve of the pressure-regulating valve arrangement is assigned to at least the wheel brakes of the brake circuit assigned to the first pressure chamber, the second wheel valve is arranged in a hydraulic connection between the pressurization device and the wheel brake.

11. The brake system as claimed in claim 10, further comprising in that the second wheel valves assigned to the wheel brakes of the first pressure chamber are configured normally closed, and that no further valve is arranged in the respective connection between the pressurization device and the second wheel valve.

12. The brake system as claimed in claim 10, further comprising in that the second wheel valves assigned to the wheel brakes of the first pressure chamber are configured normally open, and that a normally closed circuit valve is arranged in the connection between the second wheel valves and the pressurization device.

13. The brake system as claimed in claim 1 further comprising in that a second electrically controllable, normally closed wheel valve of the pressure-regulating valve arrangement is assigned to each of the wheel brakes of the brake circuit assigned to the second pressure chamber, which valve is arranged in a hydraulic connection between the wheel brake and the pressure medium storage container, wherein no further valve is arranged in the connection between the second wheel valve and the pressure medium storage container.
